(19) United States
(12) Patent Application Publication
(10) Pub. No.: US 2009/0052686 A1
(43) Pub. Date: Feb. 26, 2009

(54) ELECTRONIC DEVICE WITH AN INTERNAL MICROPHONE ARRAY

(75) Inventors: Li-Te Wu, Taipei City (TW); Yu-De Tsai, Taipei City (TW); Yi-Wen Chen, Taipei City (TW); Sung-Kai Yang, Xinzhuang City (TW); Kuo-Yu Lin, San Jose, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 11/843,692

(22) Filed: Aug. 23, 2007

(51) Int. Cl. H04R 3/00

(52) U.S. Cl. 381/92

(57) ABSTRACT

An electronic device includes a front cover, a circuit board, a plurality of flexible boots, a plurality of microphones, and an abutting mechanism. The front cover includes a plurality of wall portions, a plurality of storage spaces encircled by the wall portions, and a plurality of acoustic openings connecting to the storage spaces. The flexible boots are disposed in the storage spaces. The microphones are mounted on the circuit board and disposed in the boots. The abutting mechanism pushes the circuit board toward the front cover to squeeze the flexible boot.

### BACKGROUND OF THE INVENTION

1. Field of the Invention

The invention relates to an electronic device, and more particularly to an electronic device with an internal microphone array.

2. Description of the Related Art

A microphone array is capable of clearly receiving sound from a particular direction while avoiding surrounding noise, and is often applied in high-quality audio recorders or communications devices.

A typical microphone array includes a number of microphones disposed in tandem. Referring to FIG. 1, a simple example is shown wherein the microphone array 10 includes two microphones 11 and 12 placed side by side. Directivities of the microphone array 10 can be achieved by manipulating the signal received by the two microphones 11 and 12. Assuming the two microphones 11 and 12 are omni-directional and have the same characteristics, the directivity of the microphone array 10 depends on the distance D between the two microphones 11 and 12.

The disclosed microphones 11 and 12 are placed in an open space for achieving directivity. Most electronic devices (cellular phones, personal digital assistants, notebook computer, etc.), however, have plastic or metal housings, which are acoustic isolators. Acoustic isolators block audio signals increasing difficulty with microphone placement. Specifically, microphone array performance, acceptable in an open space, deteriorates when disposed in a housing of an electronic device, because reception of external sound is hindered by the housing. Also, sound leakage and cross talk between the microphones need to be avoided when the microphone array is disposed in the housing of an electronic device.

### BRIEF SUMMARY OF THE INVENTION

The invention provides an electronic device comprising an internal microphone array capable of adequate performance.

The electronic device may comprise a front cover, a circuit board, a plurality of flexible boots, a plurality of microphones, and an abutting mechanism. The front cover comprises a plurality of wall portions, a plurality of storage spaces encircled with the wall portions, and a plurality of acoustic openings connecting to the storage spaces. The flexible boots are disposed in the storage spaces. The microphones are mounted on the circuit board and disposed in the boots. The abutting mechanism pushes the circuit board toward the front cover to squeeze the flexible boot.

The electronic device may further comprise a rear cover, and the abutting mechanism protrudes from the rear cover.

The abutting mechanism may comprise a plurality of ribs protruding from the rear cover.

The ribs may be symmetrically arranged.

The ribs may comprise a central rib and two side ribs on opposite sides of the central rib.

The circuit board may comprise a first surface with the microphones mounted thereon, a second surface opposing the first surface, an integrated circuit chip mounted on the second surface, and a polyester film covering the integrated circuit chip, wherein the central rib contacts the polyester film.

The abutting mechanism may comprise a resilient piece fixed to the rear cover.

The microphones may be equally distant from a central line passing through the circuit board at a location where the resilient piece pushes the circuit board.

The circuit board may comprise a first surface with the microphones mounted thereon, a second surface opposing the first surface, an integrated circuit chip mounted on the second surface, and a polyester film covering the integrated circuit chip, wherein the resilient piece contacts the polyester film.

The abutting mechanism may comprise a screw connecting the circuit board and the front cover.

The microphones may be equally distant from the screw.

The flexible rubber may be made of rubber.

The microphones may comprise two omni-directional microphones.

The microphones may constitute a microphone array.

The electronic device may be a notebook computer, a cellular phone, a personal digital assistant (PDA), a global positioning system (GPS) receiver, a liquid crystal display (LCD), a speakerphone, or others.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 depicts a typical microphone array including two microphones placed side by side;

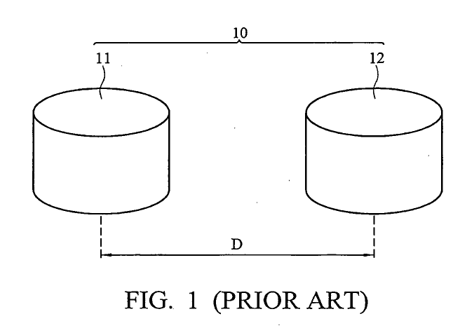

FIG. 2 is a schematic view showing an electronic device with an internal microphone array in accordance with a first embodiment of the invention;

FIG. 3 is a sectional view of FIG. 2 along line III-III;

FIG. 4 is a sectional view showing an electronic device with an internal microphone array in accordance with a second embodiment of the invention; and

FIG. 5 is a sectional view showing an electronic device with an internal microphone array in accordance with a third embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

While a notebook computer is utilized for purposes of illustration, it is understood that the invention is equally applicable to a variety of electronic devices including cellular phones, personal digital assistants (PDAs), global positioning system (GPS) receivers, liquid crystal displays (LCDs), speakerphones, and others.

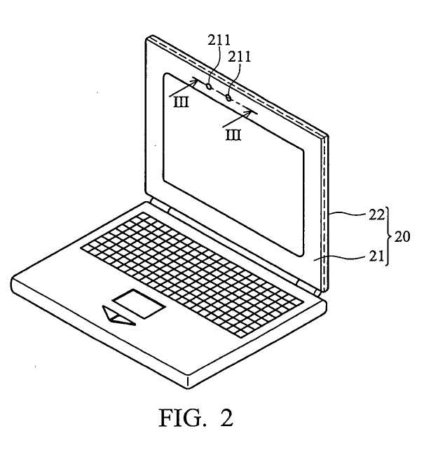

Referring to FIG. 2, an electronic device 2 of a first embodiment of the invention includes a housing 20. The housing 20 has a front cover 21 and a rear cover 22. A plurality of acoustic openings 211 is provided in the front cover 21 allowing external sound to enter.

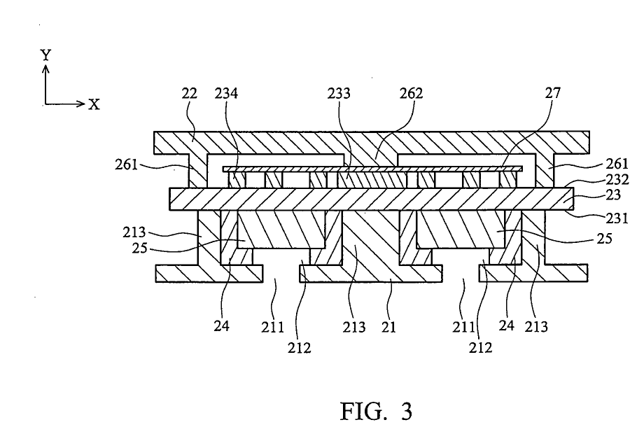

Referring to FIG. 3, the front cover 21 has a plurality of wall portions 213 protruding inward to form a plurality of storage spaces 212. That is, the storage spaces 212 are encircled by the wall portions 213. Also, the acoustic openings 211 of the front cover 21 are connected to the storage spaces 212.

A circuit board 23 has a first surface 231, a second surface 232 opposing the first surface 231, an integrated circuit chip 233 mounted on the second surface 232, and a plurality of electronic components 234 also mounted on the second surface 232. Two omni-directional microphones 25, mounted on the first surface 231 of the circuit board 23, constitute a microphone array. The two omni-directional microphones 25 are fitted into two flexible boots 24 and then disposed in the storage spaces 212. Thus, the omni-directional microphones 25 are capable of receiving external sound via the acoustic opening 211 of the front cover 21.

The flexible boots 24 are made of, for example, rubber.

Mylar is a trademark used for a thin strong polyester film. In the first embodiment, a Mylar film 27 is attached to the integrated circuit chip 233 and electronic components 234. The Mylar film 27 is about 2 mm in thickness, and is used to protect the integrated circuit chip 233 and electronic components 234 from electrostatic charge damage and shorting.

An abutting mechanism, including a central rib 262 and two side ribs 261 on opposite sides of the central rib 262, protrudes from the rear cover 22 and pushes the circuit board 23 toward the front cover 21. As shown in FIG. 3, the central rib 262 contacts the Mylar film 27, while the side ribs 261 contact the circuit board 23.

The flexible boots 24 not only protects the internal omni-directional microphones 25 from vibrations but also avoids sound leakage. To begin, the flexible boots 24 are slightly larger than the storage spaces 212. However, the ribs 261 and 262 of the abutting mechanism push the circuit board 23 toward the front cover 21. Thus, the flexible boots 24 are squeezed and contracted until the circuit board 23 contacts the wall portions 213 of the front cover 21. As a result, the flexible boots 24 are tightly held between the omni-directional microphones 25 and the wall portions 213 to avoid any sound leakage. Also, the omni-directional microphones 25 in the storage spaces 212 can only receive external sound via the acoustic openings 211.

During operation, sound is received by the omni-directional microphones 25 and then processed by a digital signal processor, DSP (not shown). Incorrect positions of the omni-directional microphones 25, however, negatively influence the operations of the digital signal processor (DSP) including beam forming, echo cancellation, noise suppression and others. In the first embodiment, therefore, the two omni-directional microphones 25 are precisely positioned in both directions X and Y to avoid the negative influences. The omni-directional microphones 25 are mounted on the circuit board 23. Thus, the distance between the omni-directional microphones 25 in direction X can be precisely maintained in accordance with design. Furthermore, the ribs 261 and 262 of the abutting mechanism push the circuit board 23 toward the front cover 21. Thus, the two omni-directional microphones 25 can be maintained in the same position in direction Y. Note that the ribs 261 and 262 are symmetrically arranged to apply the same force to the flexible boots 24 in order to keep the omni-directional microphones 25 at the same level.

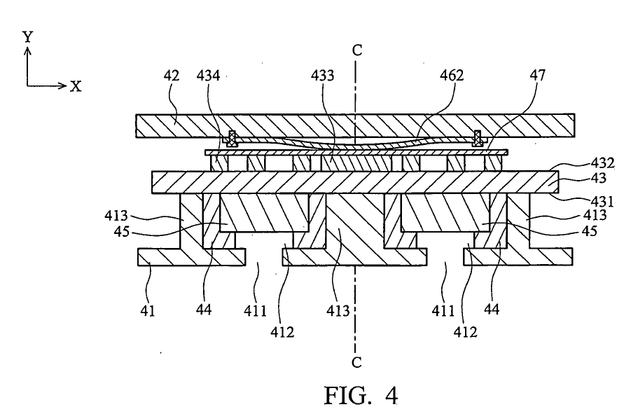

Referring to FIG. 4, an electronic device 4 of a second embodiment of the invention has a front cover 41 and a rear cover 42. A plurality of acoustic openings 411 is provided in the front cover 41 allowing external sound to enter. The front cover 41 has a plurality of wall portions 413 protruding inward to form a plurality of storage spaces 412. That is, the storage spaces 412 are encircled with the wall portions 413. Also, the acoustic openings 411 of the front cover 41 are connected to the storage spaces 412.

A circuit board 43 has a first surface 431, a second surface 432 opposing the first surface 431, an integrated circuit chip 433 mounted on the second surface 432, and a plurality of electronic components 434 also mounted on the second surface 432. Two omni-directional microphones 45, mounted on the first surface 431 of the circuit board 43, constitute a microphone array. The two omni-directional microphones 45 are fitted into two flexible boots 44 and then disposed in the storage spaces 412. Thus, the omni-directional microphones 45 are capable of receiving external sound via the acoustic opening 411 of the front cover 41.

The flexible boots 44 are made of, for example, rubber.

In the second embodiment, a Mylar film 47 is attached to the integrated circuit chip 433 and electronic components 434. The Mylar film 47 is about 2 mm in thickness, and is used to protect the integrated circuit chip 433 and electronic components 434 from electrostatic charge damage and shorting.

As shown in FIG. 4, a resilient piece 462 is curved and fixed to the rear cover 42 at both ends. The resilient piece 462 contacts the Mylar film 47 for pushing the circuit board 43 toward the front cover 41.

The flexible boots 44 not only protects the internal omni-directional microphones 45 from vibrations but also avoids sound leakage. To begin, the flexible boots 44 are slightly larger than the storage spaces 412. However, the resilient piece 462 pushes the circuit board 43 toward the front cover 41. Thus, the flexible boots 44 are squeezed and contracted until the circuit board 43 contacts the wall portions 413 of the front cover 41. As a result, the flexible boots 44 are tightly held between the omni-directional microphones 45 and the wall portions 413 to avoid any sound leakage. Also, the omni-directional microphones 45 in the storage spaces 412 can only receive external sound via the acoustic openings 411.

During operation, sound is received by the omni-directional microphones 45 and then processed by a digital signal processor, DSP (not shown). Incorrect positions of the omni-directional microphones 45, however, negatively influence the operations of the digital signal processor (DSP) including beam forming, echo cancellation, noise suppression, and others. In the second embodiment, therefore, the two omni-directional microphones 45 are precisely positioned in both directions X and Y to avoid the negative influence. The omni-directional microphones 45 are mounted on the circuit board 43. Thus, the distance between the omni-directional microphones 45 in directional X can be precisely maintained in accordance with design. Furthermore, the resilient piece 462 pushes the circuit board 43 toward the front cover 41. Note that the omni-directional microphones 45 are equally distant from a central line C-C which passes through the circuit board 43 at a location where the resilient piece 462 pushes the circuit board 43. This ensures that the flexible boots 44 sustain the same force so that the omni-directional microphones 45 can be kept at the same level. That is, the two omni-directional microphones 45 can be maintained in the same position in directional Y.

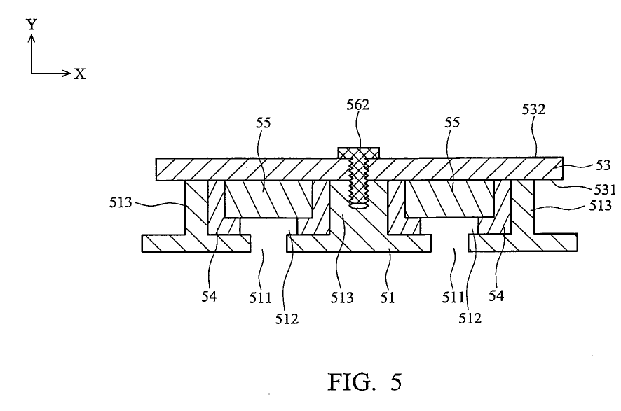

Referring to FIG. 5, an electronic device 5 of a third embodiment of the invention has a front cover 51 and a rear cover (not shown). A plurality of acoustic openings 511 is provided in the front cover 51 allowing external sound to enter. The front cover 51 has a plurality of wall portions 513 protruding inward to form a plurality of storage spaces 512. That is, the storage spaces 512 are encircled by the wall portions 513. Also, the acoustic openings 511 of the front cover 51 are connected to the storage spaces 512.

A circuit board 53 has a first surface 531 and a second surface 532 opposing the first surface 531. In the third embodiment, no integrated circuit chip or electronic components are mounted on the second surface 532. Two omni-directional microphones 55, mounted on the first surface 531 of the circuit board 53, constitute a microphone array. The two omni-directional microphones 55 are fitted into two flexible boots 54 and then disposed in the storage spaces 512. Thus, the omni-directional microphones 55 are capable of receiving external sound via the acoustic opening 511 of the front cover 51.

The flexible boots 54 are made of, for example, rubber.

In the third embodiment, a screw 562 connects the circuit board 53 to the wall portion 513 of the front cover 51. The screw 562 can be twisted for pushing the circuit board 53 toward the front cover 51.

The flexible boots 54 not only protects the internal omni-directional microphones 55 from vibrations but also avoids sound leakage. To begin, the flexible boots 54 are slightly larger than the storage spaces 512. However, the screw 562 pushes the circuit board 53 toward the front cover 51. Thus, the flexible boots 54 are squeezed and contracted until the circuit board 53 contacts the wall portions 513 of the front cover 51. As a result, the flexible boots 54 are tightly held between the omni-directional microphones 55 and the wall portions 513 to avoid any sound leakage. Also, the omni-directional microphones 55 in the storage spaces 512 can only receive external sound via the acoustic openings 511.

During operation, sound is received by the omni-directional microphones 55 and then processed by a digital signal processor, DSP (not shown). Incorrect positions of the omni-directional microphones 55, however, negatively influence the operations of the digital signal processor (DSP) including beam forming, echo cancellation, noise suppression, and others. In the third embodiment, therefore, the two omni-directional microphones 55 are precisely positioned in both directions X and Y to avoid the negative influence. The omni-directional microphones 55 are mounted on the circuit board 53. Thus, the distance between the omni-directional microphones 55 in direction X can be precisely maintained in accordance with design. Furthermore, the screw 562 pushes the circuit board 53 toward the front cover 51. Note that the omni-directional microphones 55 are equally distant from the screw 562. This ensures that the flexible boots 54 sustain the same force so that the omni-directional microphones 55 can be kept at the same level. That is, the two omni-directional microphones 55 can be maintained in the same position in directional Y.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a front cover comprising a plurality of wall portions, a plurality of storage spaces encircled by the wall portions, and a plurality of acoustic openings connecting to the storage spaces;
a circuit board;
a plurality of flexible boots disposed in the storage spaces;
a plurality of microphones mounted on the circuit board and disposed in the boots; and
an abutting mechanism pushing the circuit board toward the front cover to squeeze the flexible boot.

2. The electronic device as claimed in claim 1, further comprising a rear cover, wherein the abutting mechanism protrudes from the rear cover.

3. The electronic device as claimed in claim 2, wherein the abutting mechanism comprises a plurality of ribs protruding from the rear cover.

4. The electronic device as claimed in claim 3, wherein the ribs are symmetrically arranged.

5. The electronic device as claimed in claim 3, wherein the ribs comprise a central rib, and two side ribs on opposite sides of the central rib.

6. The electronic device as claimed in claim 5, wherein the circuit board comprises a first surface with the microphones mounted thereon, a second surface opposing the first surface, an integrated circuit chip mounted on the second surface, and a polyester film covering the integrated circuit chip, wherein the central rib contacts the polyester film.

7. The electronic device as claimed in claim 2, wherein the abutting mechanism comprises a resilient piece fixed to the rear cover.

8. The electronic device as claimed in claim 7, wherein the microphones are equally distant from a central line passing through the circuit board at a location where the resilient piece pushes the circuit board.

9. The electronic device as claimed in claim 7, wherein the circuit board comprises a first surface with the microphones mounted thereon, a second surface opposing the first surface, an integrated circuit chip mounted on the second surface, and a polyester film covering the integrated circuit chip, wherein the resilient piece contacts the polyester film.

10. The electronic device as claimed in claim 1, wherein the abutting mechanism comprises a screw connecting the circuit board and the front cover.

11. The electronic device as claimed in claim 10, wherein the microphones are equally distant from the screw.

12. The electronic device as claimed in claim 1, wherein the flexible rubber is made of rubber.

13. The electronic device as claimed in claim 1, wherein the microphones comprise two omni-directional microphones.

14. The electronic device as claimed in claim 1, wherein the microphones constitute a microphone array.

15. The electronic device as claimed in claim 1, wherein the electronic device is a notebook computer.

16. The electronic device as claimed in claim 1, wherein the electronic device is a cellular phone.

17. The electronic device as claimed in claim 1, wherein the electronic device is a personal digital assistant.

18. The electronic device as claimed in claim 1, wherein the electronic device is a global positioning system receiver.

19. The electronic device as claimed in claim 1, wherein the electronic device is a liquid crystal display.

20. The electronic device as claimed in claim 1, wherein the electronic device is a speakerphone.
